(19) United States
(12) Patent Application Publication
(10) Pub. No.: US 2008/0203826 A1
(43) Pub. Date: Aug. 28, 2008

(54) Distributing Board Embedded Panel Transformer

(76) Inventor: Woon Tae Chung, Busan (KR)

Correspondence Address: FRANKLIN & ASSOCIATES INTERNATIONAL LLC, 230 St. Francis Drive, Suite 1, SANTA FE, NM, 87505-3538, US

(21) Appl. No.: 11/913,356

(22) PCT Filed: May 2, 2006
(86) PCT No.: PCT/KR2006/001655

§ 371 Date: Nov. 1, 2007

(30) Foreign Application Priority Data
May 2, 2005 (KR) 10-2005-0037337
May 31, 2005 (KR) 10-2005-0047051
Apr. 29, 2006 (KR) 10-2006-0039105

(51) Int. Cl. H02B 1/015

(52) U.S. Cl. 307/131

(57) ABSTRACT

The present invention relates to a distribution board having an embedded panel transformer. The distribution board includes a panel transformation unit (B), a terminal box (200), a converter (210), and a control unit (300). The panel transformation unit includes a plurality of panel transformers (A). Each of the panel transformers includes a transformer (130) having the same capacity and the same load characteristics, and an automatic circuit breaker (140) for connecting or disconnecting the transformer to or from a load. In the terminal box, low voltage power is connected to a low voltage cable. The converter is installed in the terminal box, and detects the amount of load current flowing through the low voltage cable. The control unit compares the amount of load current with a preset reference data value, operates automatic circuit breakers, and connects or disconnects corresponding panel transformers to or from the load.

### TECHNICAL FIELD

The present invention relates, in general, to a distribution board having an embedded panel transformer and, more particularly, to a distribution board having an embedded panel transformer, which can simply control the number of operating panel transformers depending on a load on a distribution board for dropping an extra-high voltage to a high voltage or a low voltage and supplying the high voltage or low voltage to each building.

### BACKGROUND ART

Generally, since a typical method of selecting the capacity of a transformer does not enable precise calculation of a load capacity at the time of designing and constructing a building, the capacity of a transformer is calculated with reference to a table of power load densities for buildings and the gross area of the corresponding building, and a standard capacity is obtained from the table of standard transformer capacities. Transformer capacities are standardized to 3, 5, 7.5, 10, 15, 20, 30, 50, 75, 100 KVA, . . . , regardless of single-phase and three-phase transformers.

Further, in a consumer unit for which a standard transformer capacity has been selected and is being used, when too high a standard transformer capacity is calculated, or when a standard transformer capacity is calculated using detailed load information, but too high a transformer capacity is calculated for several reasons occurring at the time of use, such as non-use of some loads, it is impossible in practice to remove a single large capacity transformer, replace the transformer with a new transformer suitable for the load capacity, and use the new transformer, due to the cost of the expensive transformer, the redesign expenses, the replacement of some distribution boards, the construction period, etc.

Therefore, an owner or an enterpriser encounters difficulty in managing an enterprise due to an increase in installation costs caused by the installation of an excessive number of substations, excessive levying of basic charges caused by excessive contract power from Korea Electric Power Corporation, and an increase in power rates caused by an increase in the no-load loss of a transformer in the middle of the night, from the beginning of construction.

### DISCLOSURE OF INVENTION

### Technical Problem

Accordingly, the present invention has been made keeping in mind the above problems occurring in the prior art, and an object of the present invention is to provide a distribution board having an embedded panel transformer, in which a plurality of panel transformers having the same characteristics for each capacity and a plurality of automatic circuit breakers are installed in parallel in a housing, and the high voltage or low voltage contact points of the automatic circuit breakers are connected to or disconnected from an electric circuit in response to a signal output from a control unit that is electrically connected to a converter for detecting the amount of load current, so that no-load loss is reduced through the operation of controlling the number of panel transformers in a low load environment, and some panel transformers are removed when the capacity of panel transformers is left over due to non-use of some loads, thus realizing a reduction in basic charges.

Another object of the present invention is to provide a distribution board having an embedded panel transformer, in which an additional distribution board is installed when a future increase in the load of a consumer unit is predicted, so that, if the load of the consumer unit is increased, an additional panel transformer can be conveniently installed.

### Technical Solution

In order to accomplish the above objects, the present invention provides a distribution board having an embedded panel transformer, comprising at least one panel transformer including a transformer that has a primary side high voltage power connection terminal connected to input high voltage power, a secondary side high voltage power connection terminal for outputting the high voltage power, and a secondary side low voltage power connection terminal for outputting low voltage power dropped from the input high voltage power, and that supplies usage power to a load side, and an automatic circuit breaker that is connected to the secondary side connection terminals of the transformer, has a high voltage contact point output terminal for outputting the high voltage power input from the transformer and a low voltage contact point output terminal for outputting low voltage power input from the transformer, and connects or disconnects the transformer to or from a load; a panel transformation unit including a plurality of panel transformers connected to each other in such a way that a high voltage contact point output terminal of an automatic circuit breaker, constituting a first side panel transformer, is connected to a primary side high voltage power connection terminal of a transformer, constituting a second side panel transformer; a terminal box in which low voltage power output from an automatic circuit breaker of each panel transformer, constituting the panel transformation unit, is connected to a low voltage cable; a converter installed in the terminal box, and adapted to detect the amount of load current flowing through the low voltage cable connected to the automatic circuit breaker; and a control unit for comparing the amount of load current detected by the converter with a preset reference data value, operating respective automatic circuit breakers, and connecting or disconnecting corresponding panel transformers to or from the load in response to load variation, thus controlling the number of operating panel transformers.

Preferably, each of the automatic circuit breakers may comprise a low voltage contact point input terminal connected to the secondary side low voltage power connection terminal of the transformer on an upper portion on a first side of the automatic circuit breaker, and provided with a low voltage contact point for connecting or disconnecting the low voltage power; a high voltage contact point input terminal connected to the secondary side high voltage power connection terminal of the transformer on a lower portion on the first side of the automatic circuit breaker, and provided with a high voltage contact point for connecting or disconnecting the high voltage power; and a high voltage power output terminal for outputting the high voltage power input from the transformer on a lower portion on a second side of the automatic circuit breaker.

Preferably, the transformers may be implemented as single-phase (1Φ) or three-phase (3Φ) transformers, are standardized for each capacity, and have the same load characteristics.

Preferably, the load characteristics may be characteristics of capacity, polarity, primary and secondary voltages, a ratio of resistance to reactance, angular displacement, phase rotation direction, and impedance voltage.

Preferably, the panel transformers may be implemented so that a plurality of panel transformers is connected in parallel to externally applied high voltage power.

Preferably, the distribution board may further comprise at least one high voltage circuit breaker placed in front of the plurality of panel transformers for inputting the high voltage power, and operated to open a corresponding high voltage contact point when an internal fault is developed in a corresponding panel transformer, thus protecting an entire circuit.

3. Advantageous Effects

As described above, according to the present invention, there are advantages in that a plurality of panel transformers having the same characteristics is mounted in a housing to implement a distribution board, so that the installation space is reduced, thus maximizing the convenience of installing a distribution board, and improving convenience in transporting the distribution board.

Further, according to the present invention, there is an advantage in that, since panel transformers are individually constructed, the present invention can actively cope with load variation by controlling the number of operating panel transformers when the load on the distribution board is low, thus reducing power demand charges.

Further, according to the present invention, there is an advantage in that, if excess capacity of panel transformers is left over due to non-use of some loads, unnecessary panel transformers are removed and basic charges are reduced, whereas, if the load increases, an additional panel transformer is simply installed, and additional construction cost is reduced and the construction period is shortened. Further, if a panel transformer develops a fault, only the faulty panel transformer need be replaced, and thus the cost of materials is also reduced.

Further, according to the present invention, there is an advantage in that, if the panel transformer is installed in a ship, etc., only a faulty panel transformer is removed and a load is decreased even when a main transformer develops a fault, so that power can be stably supplied to the load in proportion to the capacity of the panel transformer, thus improving stability.

Further, according to the present invention, there is an advantage in that, when a consumer replaces a previously installed transformer, only a scrap metal price is paid for the existing transformer, and thus the consumer is greatly disadvantaged, but a panel transformer is a standardized transformer, so unnecessary panel transformers can be put on the market and be sold at suitable prices, and, additionally, an advantage exists from the standpoint of recycling of resources.

Further, according to the present invention, there is an advantage in that installation costs for additional power stations and substations can be reduced because of the reduction of loss upon the transmission of electricity by Korea Electric Power Corporation and the additional security of standby power, so that the present invention can reduce the use of fossil fuel, and contribute to the prevention of pollution, the greenhouse effect, and the emission of carbon dioxide.

### BRIEF DESCRIPTION OF THE DRAWINGS

FIG. 1 is an external perspective view of a distribution board having an embedded panel transformer according to an embodiment of the present invention;

FIG. 2 is a perspective view schematically showing a panel transformer according to an embodiment of the present invention;

FIG. 3 is a view showing the internal wiring of an automatic circuit breaker according to the present invention;

FIG. 4 is a perspective view schematically showing the inside of a distribution board having an embedded panel transformer according to an embodiment of the present invention;

FIG. 5 is a side view showing the inside of FIG. 4;

FIG. 6 is a top view schematically showing the inside of the distribution board of FIG. 4;

FIG. 7 is a perspective view schematically showing a panel transformer A′ according to an embodiment of the present invention;

FIG. 8 is a perspective view schematically showing the inside of a distribution board having the panel transformer A′ according to another embodiment of the present invention;

FIG. 9 is a top view schematically showing the inside of the distribution board of FIG. 8;

FIG. 10 is a view showing the internal wiring of a distribution board having an embedded panel transformer according to an embodiment of the present invention;

FIG. 11 is a single-line diagram of FIG. 10;

FIG. 12 is a view showing the internal wiring of an automatic circuit breaker according to another embodiment of the present invention;

FIG. 13 is a view showing the internal wiring of a distribution board having an embedded panel transformer, including the automatic circuit breaker and the low voltage circuit breaker of FIG. 12 installed therein;

FIG. 14 is a single-line diagram of FIG. 13; and

FIG. 15 is a top view showing the inside of an auxiliary distribution board according to another embodiment of the present invention.

Reference characters of important parts in the drawings are described as follows.

10: housing 12: external door

14: see-through window 16: monitoring see-through window

18: ventilation fan 20: distribution board hoist ring

22: auxiliary distribution board 110: high voltage cable

120: high voltage circuit breaker A: panel transformer

130, 130-1, 130-2: single phase transformer

130a: primary side high voltage power connection terminal

130b: secondary side low voltage power connection terminal

130c: secondary side high voltage power connection terminal

132: hoist ring 131, 131-1, 131-2: three-phase transformer

140, 140-1, 140-2: single phase automatic circuit breaker

140a: lower voltage contact point input terminal

140b: high voltage contact point input terminal

140c: high voltage contact point output terminal

141, 141-1, 141-2: three-phase automatic circuit breaker 142: hoist ring

144: lead terminal 146, 146-1,146-2: low voltage contact point

147, 147-1, 147-2: high voltage contact point B: panel transformation unit

150: panel transformer support 160: guard rail

162: fastening pin 170: low voltage cable

172: cable installation space 180: connection cable

180-1: passing power line 182: connection terminal

200: terminal box 210: converter

300: control unit

### BEST MODE FOR CARRYING OUT THE INVENTION

Hereinafter, a distribution board having an embedded panel transformer according to embodiments of the present invention will be described in detail with reference to the attached drawings.

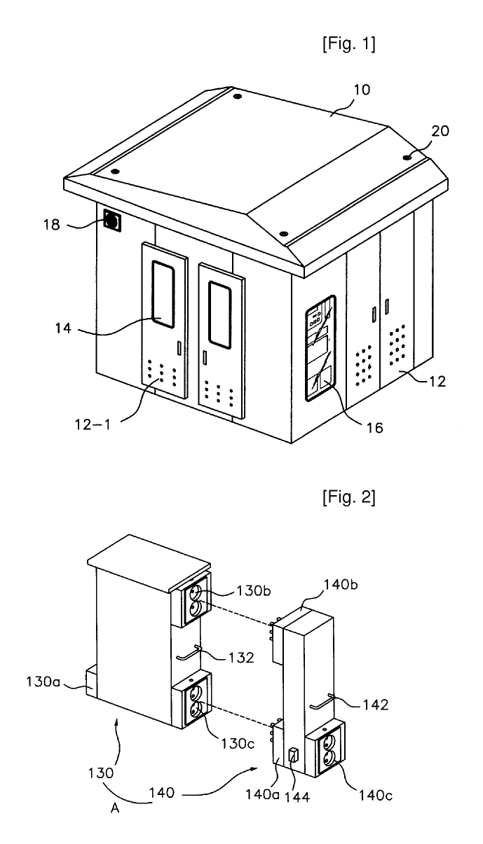

FIG. 1 is an external perspective view of a distribution board having an embedded panel transformer according to an embodiment of the present invention.

As shown in FIG. 1, the distribution board having an embedded panel transformer of the present invention includes a housing 10 having a predetermined size and an internal space.

Doors 12 required for inspection and installation of devices are openably placed on the front and rear surfaces of the housing 10. On each door 12, ventilating holes are formed to cause external air to freely flow into the door 12. Further, a ventilation fan 18 is installed on an upper portion of the housing 10 to promptly remove heat generated in the distribution board. Reference numeral 20 denotes distribution board hoist rings.

Further, on the side surface of the housing 10, an external door 12-1 having see-through windows 14 is installed, and on the front surface of the housing 10, an monitoring see-through window 16, enabling internal instruments to be observed with the naked eye, and the door 12 are installed.

Further, a panel transformation unit composed of a panel transformer, which will be described later, and an automatic circuit breaker, a panel transformer support, a guard rail, and a low voltage cable for connection between the automatic circuit breaker and a terminal box are installed in the housing 10. On the internal side surface of the housing 10, a control unit for controlling the number of operating panel transformers, and a terminal block for supplying power to a load, are installed in the terminal box 200. The door 12-1 on the side surface of the housing is installed when a single distribution board having an embedded panel transformer is installed, whereas the door 12-1 may be omitted when a plurality of distribution boards each having an embedded panel transformer is installed.

FIG. 2 is a perspective view schematically showing a panel transformer A according to an embodiment of the present invention.

Referring to FIG. 2, the panel transformer A according to the present invention includes a transformer 130 and an automatic circuit breaker 140. The panel transformer A is characterized in that the transformer 130 is standardized for each capacity, and has the same load characteristics. In this case, the load characteristics denote detailed properties of a transformer, such as polarity, primary and secondary voltages, the ratio of resistance to reactance, angular displacement, phase rotating direction, and impedance voltage. The transformer 130 having the same load characteristics and the automatic circuit breaker 140 for breaking the transformer 130 are collectively designated a panel transformer A.

The transformer 130 is a single-phase (1Φ) transformer having the shape of a cylinder or a rectangular parallelepiped, and is a transformer for independently exchanging single-phase power by dropping externally applied high voltage power and by supplying usage power, which is low voltage power, to a load.

The capacity of the transformer 130 can be variously set at 3 KVA, 5 KVA, 7.5 KVA, 10 KVA, 15 KVA, 20 KVA, 30 KVA, 50 KVA, 75 KVA, 100 KVA, 150 KVA, 200 KVA, 250 KVA, 300 KVA, . . . , and can be provided in a standard capacity required for a building, etc. As the transformer 130, various types of transformers, such as an oil immersed transformer, a molded transformer, a dry-type transformer, or an amorphous transformer, can be used.

The transformer 130 according to the present invention includes a primary side high voltage power connection terminal 130a connected to applied high voltage power, a secondary side high voltage power connection terminal 130c for outputting the high voltage power, and a secondary side low voltage power connection terminal 130b for outputting low voltage power dropped from the applied high voltage power.

Further, since the primary side high voltage power connection terminal 130a and the secondary side high voltage power connection terminal 130c of the transformer 130 are parts connected to an extra-high voltage cable, they may be preferably made of epoxy resin to have high dielectric strength.

Meanwhile, the automatic circuit breaker 140 has therein a low voltage contact point and a high voltage contact point, and then functions to disconnect or connect the transformer 130 from the circuit through the operation of the two contact points.

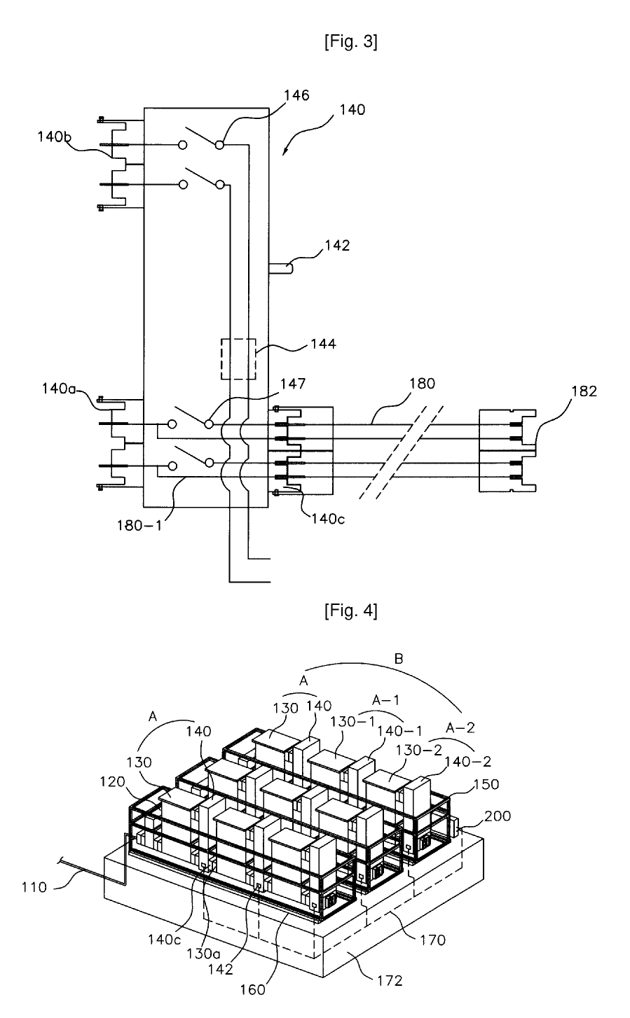

FIG. 3 is a view showing the internal wiring of the automatic circuit breaker according to the present invention.

Referring to FIG. 3, in the automatic circuit breaker 140, a low voltage input terminal 140a, which is connected to the secondary side low voltage power connection terminal 130b of the transformer 130 and which has a low voltage contact point 146 for connecting or disconnecting low voltage power, is formed on an upper portion of one side of the automatic circuit breaker 140. A high voltage contact point input terminal 140b, which is connected to the secondary side high voltage power connection terminal 130c of the transformer 130 and which has a high voltage contact point 147 for connecting or disconnecting high voltage power, is formed on a lower portion of one side of the automatic circuit breaker 140. A high voltage contact point output terminal 140c for outputting high voltage power is formed on a lower portion of the other side of the automatic circuit breaker 140.

In this case, the low voltage contact point 146 of the automatic circuit breaker 140 may be implemented using an air circuit breaker, a magnetic circuit breaker, an electromagnetic contactor, etc., and the high voltage contact point 147 may be implemented using a vacuum circuit breaker, etc.

Further, the automatic circuit breaker 140 is constructed so that a lead terminal 144 is formed on a casing to cause the automatic circuit breaker 140 to be coupled to the terminal box 200 via a low voltage cable 170, which will be described later.

The lead terminal 144 can connect to the low voltage cable 17 when the number of small capacity and large capacity consumer units is increased, so that uninterruptible operation is possible in such a way as to additionally supply temporary power, etc., through an operation of connecting or disconnecting the existing low voltage cable 170 to or from the lead terminal 144 when an increase in the number of small-capacity consumer units is required.

A connection cable 180 and an auxiliary terminal 182 shown in the drawing are a cable and an auxiliary terminal, respectively, required for power connection between a distribution board and another distribution board, or between a distribution board and an auxiliary distribution board when the total capacity of hydroelectricity panel transformers of consumer units that has been initially planned cannot be accommodated in a single distribution board having an embedded panel transformer, or when an auxiliary distribution board is installed or an additional distribution board having an embedded panel transformer is installed in consideration of an increase in load that may occur in the future.

Referring to FIG. 2 again, the primary side high voltage power connection terminal 130a of the transformer 130 is preferably formed in a typical plug type, and both the secondary side high voltage power connection terminal 130c and the low voltage power connection terminal 130b are preferably formed in a typical outlet type.

Further, both the low voltage contact point input terminal 140a and the high voltage contact point input terminal 140b of the automatic circuit breaker 140 are preferably formed in a typical outlet type, and the high voltage contact point output terminal 140c thereof is preferably formed in a typical plug type.

Further, a hoist ring 142 is formed on one side surface of the automatic circuit breaker 140, and is operated so that, if the automatic circuit breaker 140 is put into the distribution board using the hoist ring 142, the automatic circuit breaker 140 is simply coupled to the transformer 130 installed to be adjacent thereto and the panel transformer A is formed.

As described above, the transformer 130 and the automatic circuit breaker 140 of the panel transformer A are constructed in an outlet type and a plug type, respectively, thus improving convenience in operation and shortening the construction time at the time of coupling the transformer 130 to the automatic circuit breaker 140.

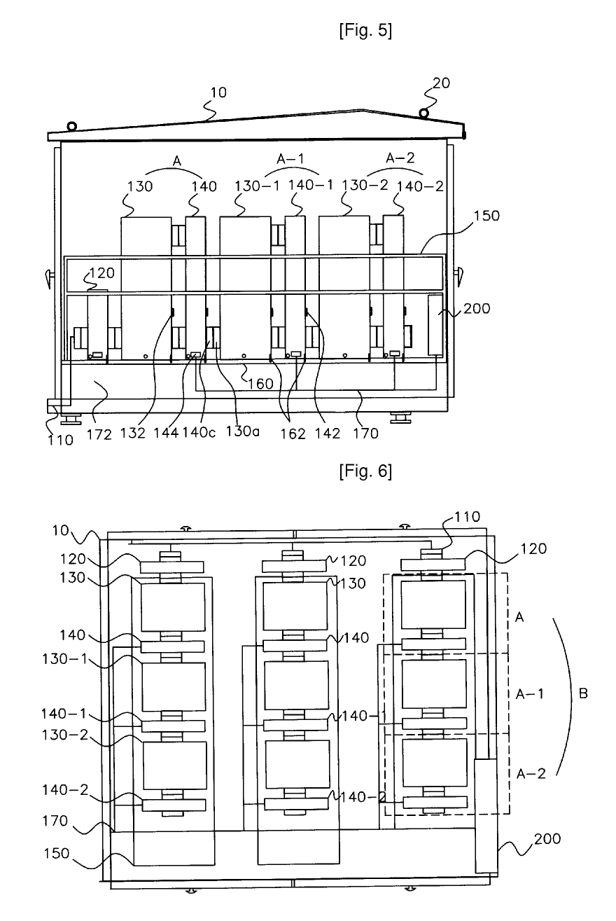

FIG. 4 is a perspective view schematically showing the inside of a distribution board having an embedded panel transformer according to an embodiment of the present invention, FIG. 5 is a side view showing the inside of FIG. 4, and FIG. 6 is a top view schematically showing the inside of the distribution board of FIG. 4.

Referring to FIGS. 4 to 6, panel transformation units B, each composed of a plurality of panel transformers A connected in parallel to externally applied high voltage power, a terminal box 200, and a control unit, are installed in the housing 10.

Each of the panel transformation units B denotes a structure in which a plurality of panel transformers A is connected to each other. A panel transformation unit B, composed of a plurality of panel transformers A, A-1 and A-2, is formed in such a way as to simply connect the panel transformers to each other by connecting the high voltage contact point output terminal 140c of an automatic circuit breaker 140, constituting one side panel transformer A, to the primary side high voltage power connection terminal 130a of the transformer 130 of the other side panel transformer, or to simply disconnect the panel transformers from each other.

As described above, the panel transformation unit B composed of the plurality of panel transformers A, A-1 and A-2 is installed in the housing 10. Each support 150 is installed around the panel transformation unit B to support the panel transformation unit B in order to prevent the panel transformation unit B from falling down due to physical impacts.

Further, each of the panel transformers A, A-1 and A-2 is arranged to be movably placed on a guard rail (160) installed on the bottom of the housing 10, and can be conveniently moved when the panel transformer is installed or removed.

Further, the removal of the panel transformer A from the housing 10 is conveniently performed in such a way that a fastening pin 162 between the transformer 130 and the guard rail 160 is pulled out, and the hoist ring 132 or 142 attached to a portion of the transformer 130 or the automatic circuit breaker 140 is pulled.

Further, the terminal box 200 includes a converter therein, receives the amount of load current detected by the converter, and transmits the detected amount of load current to a control unit (not shown) electrically connected thereto. The control unit compares the received amount of load current with a preset reference data value, and operates the automatic circuit breaker 140 of each panel transformer A, thus connecting or disconnecting the panel transformer A to or from the load.

A cable installation space 172 is formed below the guard rail 160.

Meanwhile, the distribution board having an embedded panel transformer according to the present invention includes a high voltage circuit breaker 120 placed in front of the first panel transformer A connected to externally applied high voltage power.

The high voltage circuit breaker 120 is installed to open an internal high voltage contact point and to separate the first panel transformer A from the circuit when the first panel transformer A develops a fault due to overcurrent caused by externally applied high voltage power, or a short-circuit between layers, thus preventing a hazard from spreading. The high voltage circuit breaker 120 has therein an overcurrent relay or a ground relay, and automatically breaks the circuit when abnormal current is generated in the first panel transformer 130.

FIG. 7 is a perspective view schematically showing a panel transformer A′ according to an embodiment of the present invention.

Referring to FIG. 7, the panel transformer A′ according to the present invention includes a three-phase (3Φ) transformer 131 and an automatic circuit breaker 141. As is generally known, the three-phase transformer 131 used in a distributing line is a device for converting an AC voltage or current using electromagnetic induction, and typically has a capacity of about several tens of KVA, but may have a large capacity of hundreds of thousands of KVA on a high voltage power transmission line.

The actual structure of the three-phase transformer 131 varies according to capacity or voltage, but important parts thereof are coils and iron cores. The three-phase transformer 131 is implemented in a structure in which the coils and iron cores are put in a tank and insulating oil is loaded into the tank.

The three-phase transformer 131 is constructed such that primary and secondary side connection terminals are provided on a casing, and such that a plug-type high voltage power input terminal 131a is provided on the primary side, and an outlet-type low voltage power input terminal 131b and high voltage power output terminal 131c are provided on the secondary side.

Further, the automatic circuit breaker 141 connected to the three-phase transformer 131 to constitute the panel transformer A′ is provided.

On the automatic circuit breaker 141, a low voltage contact point input terminal 141a, having a low voltage contact point, is formed on an upper portion of a primary side. A high voltage contact point input terminal 141b, having a high voltage contact point, is formed on a lower portion of the primary side. A high voltage contact point output terminal 141c for outputting high voltage power is formed on a lower portion of the secondary side.

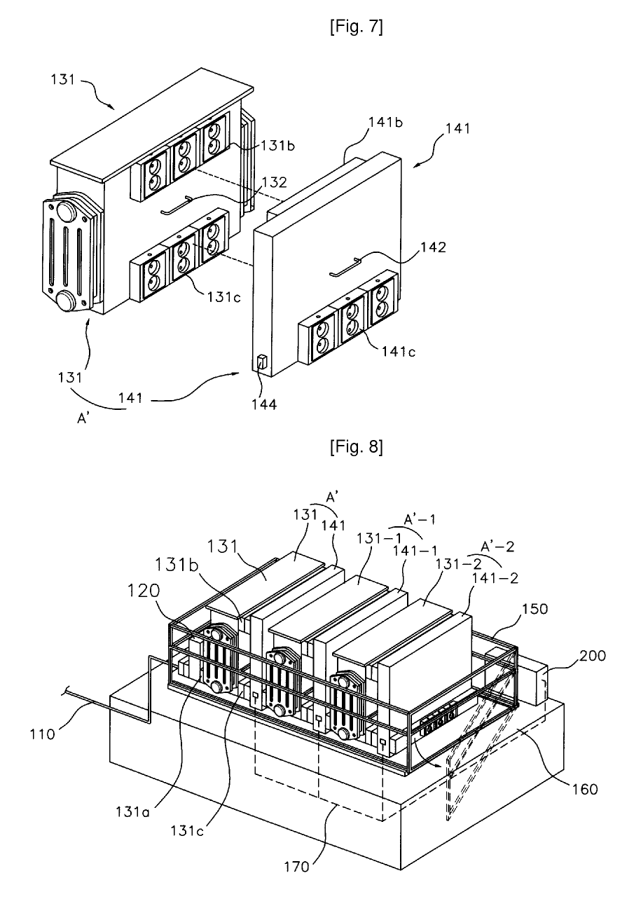

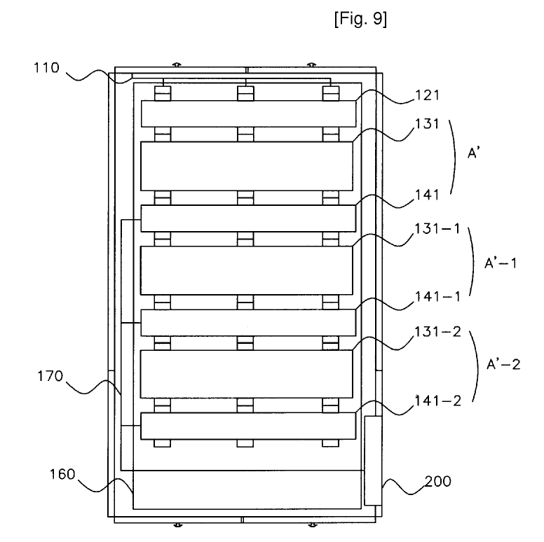

FIG. 8 is a perspective view schematically showing the inside of a distribution board having an embedded panel transformer A′ according to another embodiment of the present invention, and FIG. 9 is a top view schematically showing the inside of the distribution board of FIG. 8.

As shown in FIGS. 8 and 9, a panel transformation unit B′ composed of a plurality of panel transformers A′, A′- 1 and A′-2 connected in parallel to externally applied high voltage power 110, a terminal box 200 and a control unit 300 are installed in a housing 10.

The above components are identical to those of the panel transformer A having the single-phase transformer 130, so a detailed description thereof is omitted.

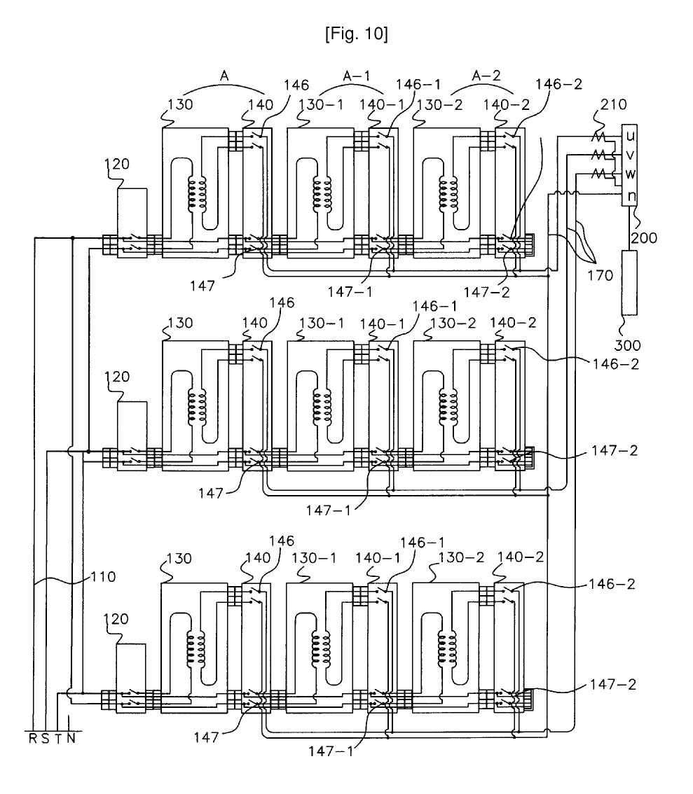

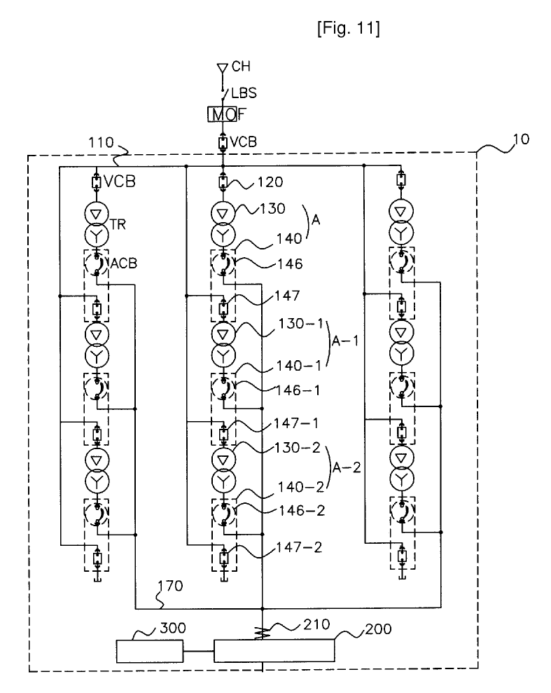

FIG. 10 is a view showing the internal wiring of a distribution board having an embedded panel transformer according to an embodiment of the present invention, and FIG. 11 is a single-line diagram of FIG. 10.

Referring to FIGS. 10 and 11, the distribution board according to this embodiment includes 3 high voltage circuit breakers 120, 120-1 and 120-2, and 9 panel transformers A, A-1 and A-2, composed of transformers 130, 130-1 and 130-2, and automatic circuit breakers 140, 140-1 and 140-2, respectively.

In the drawing, since the high voltage circuit breakers 120 and the panel transformers A are single-phase devices, 3 single-phase devices must function as a single device so as to supply electricity in a three-phase manner, so that the same reference numeral is used for the 3 high voltage circuit breakers or the 3 panel transformers. The low voltage contact points 146, 146-1 and 146-2 and the high voltage contact points 147, 147-1 and 147-2 of the automatic circuit breakers 140, 140-1 and 140-2 of the panel transformers A are indicated in the same manner as the above method.

The distribution board having an embedded panel transformer installed in this way automatically disconnects the panel transformers A from a load for a time period, during which a load is decreased, among daytime periods, and automatically connects the panel transformers A to a load when the load is increased again, so that the panel transformers can be used.

That is, 9 panel transformers A are connected to a load, and then the converter 210 installed in the terminal box 200 detects the amount of load current, flowing through the low voltage cable 170, in operation, and transmits the detected amount of load current to a control unit 300.

The control unit 300 compares the received amount of load current with a preset reference data value, and operates respective contact points 147-1 and 146-2 of the 6 automatic circuit breakers 140-1 and 140-2 of the panel transformers A if the load current is equal to or less than a certain value for a predetermined period of time (seconds or minutes), thus disconnecting the 3 panel transformers A-2 from the circuit.

Further, if a load is decreased at night during operation in the above state, even the high voltage contact points 147 and the low voltage contact points 146-1 of the automatic circuit breakers 140 and 140-1 of the panel transformers A are operated to additionally disconnect 3 panel transformers A-1 from the load. Consequently, a total of 6 panel transformers A-1 and A-2 is disconnected from the load, thus further decreasing no-load loss.

Further, if a load is gradually increased after 9 a.m., when an overnight period ends, and the converter 210 senses that the amount of load current flowing through the 3 panel transformers A reaches 90% or higher of the rated currents of the 3 panel transformers A, 3 high voltage contact points 147 of the 3 automatic circuit breakers 140 of the panel transformers A are automatically connected by the control unit 300 electrically connected to the converter 210, and thus 3 panel transformers A-1 are excited. The 3 low voltage contact points 146-1 of the 3 automatic circuit breakers 140-1 of the panel transformers A are simultaneously connected in consideration of the time at which exciting current caused by the pressure of the 3 panel transformers A-1 is extinguished, thus supplying load current to the load.

If load current corresponding to 6 panel transformers A and A-1 flows at 90% or higher of the rated current of the 6 panel transformers A and A 1, 3 high voltage contact points 147-1 of the 3 automatic circuit breakers 140-1 are connected to the load by the control unit 300. After a certain time has elapsed, the 3 low voltage contact points 146-2 of the automatic circuit breakers 140-2 are connected to the load, thus the distribution board is operated in a full load state.

Meanwhile, when a panel transformer develops a fault therein during operation, the present invention can disconnect the faulty panel transformer from the circuit using the control unit 300.

For example, when an internal fault has been developed in a center one of the 3 panel transformers A-1, unneeded distribution boards or loads are disconnected from an electric circuit by the control unit 300 in a preset sequence, at the same time that the 3 high voltage contact points 147 of 3 automatic circuit breakers 140 and the 3 low voltage contact points 146-1 of the 3 automatic circuit breakers 140-1 are operated to disconnect the panel transformer A-1 from the circuit, thus the distribution board is operated using only 6 panel transformers A and A-2.

Further, when the transformer of FIG. 11 is a large capacity panel transformer installed outdoors, the high voltage circuit breakers 120 and the automatic circuit breakers 140, 140-1 and 140-2 are replaced with large capacity gas circuit breakers (GCB). The circuit breakers are accommodated in a dedicated distribution board. The panel transformers are also implemented for voltage boosting, as well as voltage drop.

For example, the panel transformers may boost voltage power to a primary voltage of 22.9 KV, and to a secondary voltage of 354 KV, and transmit the boosted voltage to a power transmission and distribution line. When the load at the power transmission and distribution line is low, the panel transformers can be used in power stations or substations to reduce no-load loss and power transmission loss of the panel transformers through opening and closing of the contact points of the automatic circuit breakers 140, 140-1 and 140-2.

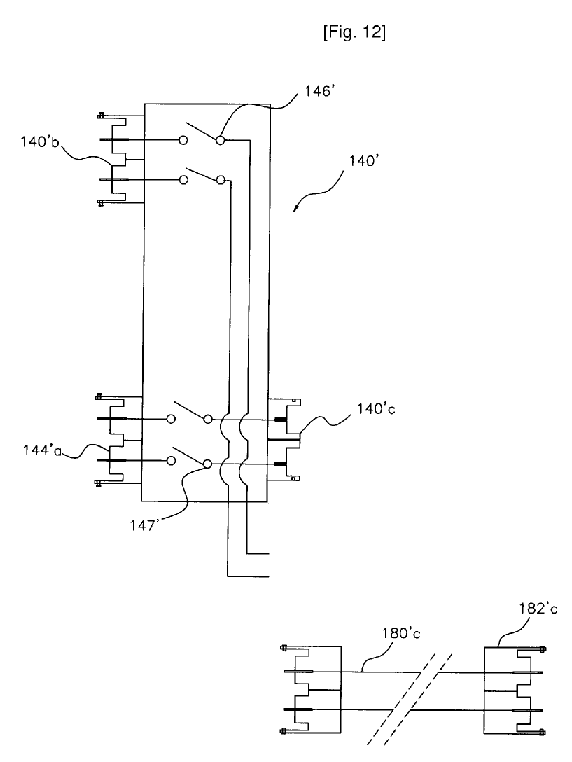

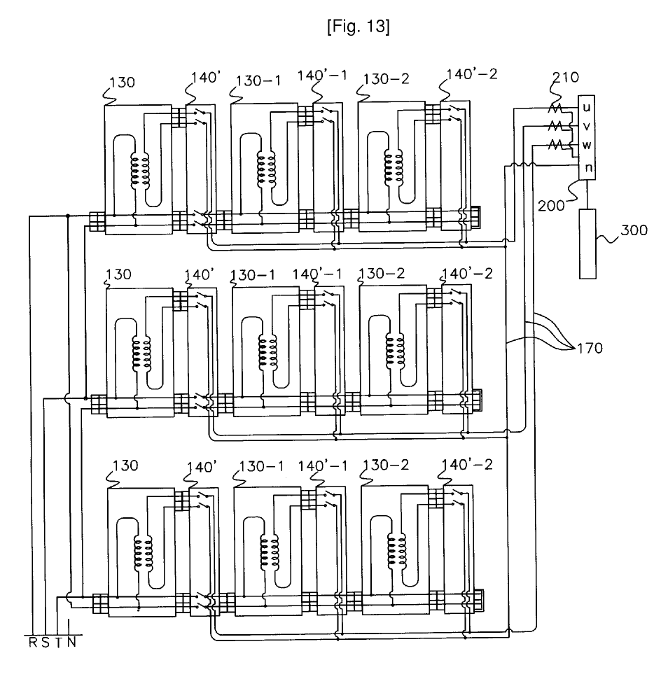

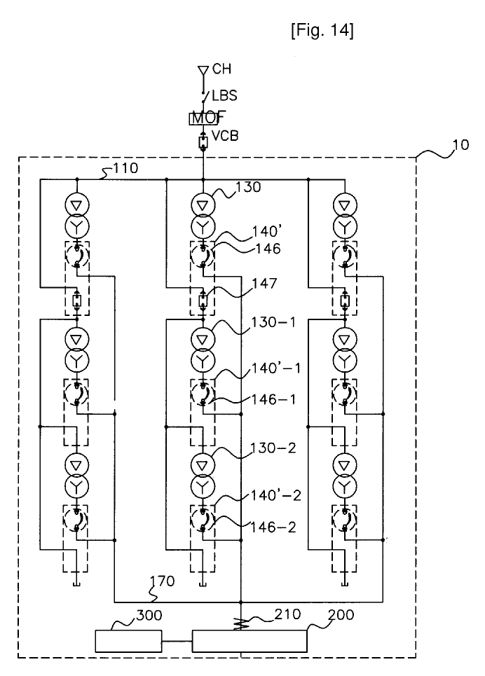

FIG. 12 illustrates an automatic circuit breaker according to another embodiment of the present invention, which shows the internal wiring of an automatic circuit breaker having no passing power line except for high voltage contact points, unlike the embodiment of FIG. 9. FIG. 13 is a view showing the internal wiring of a distribution board having an embedded panel transformer, including the automatic circuit breaker and the low voltage circuit breaker of FIG. 12 installed therein, and FIG. 14 is a single-line diagram of FIG. 13.

Referring to FIGS. 12 to 14, the above embodiment is required to reduce the number of high voltage circuit breakers 120 installed, and to install low voltage circuit breakers 140′-1 an 140′-2 having only low voltage contact points, thus reducing installation costs.

Therefore, the number of high voltage circuit breakers 120 is reduced, and thus installation costs can be reduced. Automatic circuit breakers 140′ having no passing power line are installed to disconnect the low voltage circuit breakers 140′-1 and 140′-2 from the circuit when an internal fault is developed in the low voltage circuit breakers 140′-1 and 140′-2, and to reduce no-load loss occurring at night.

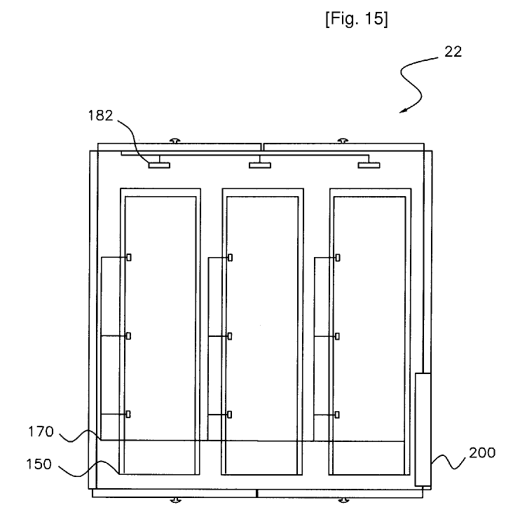

FIG. 15 is a top view showing the inside of an auxiliary distribution board 22 according to another embodiment of the present invention.

The auxiliary distribution board 22 includes supports 150 for supporting panel transformers A additionally provided in a housing 10, a low voltage cable 170 for connection between automatic circuit breakers and a terminal box 200, the terminal box 200, and auxiliary terminals 182, so that panel transformers A can be freely and additionally installed, thus simply increasing the overall load capacity.

That is, the transformer 130 and the automatic circuit breaker 140 of the panel transformer A are implemented in an outlet type and a plug type, respectively. Accordingly, if it is determined that a load is increased or the capacity of the installed panel transformer A is insufficient, the transformer 130 and the automatic circuit breaker 140 of the panel transformer A need only be sequentially put into the distribution board and be simply installed.

Further, in the case of medium and large capacity panel transformers, a single panel transformer A is installed in each distribution board (equally applied to single-phase and three-phase transformers) or installed indoors or outdoors without being installed in a distribution board, in order to perform parallel operation if necessary. High voltage circuit breakers or automatic circuit breakers (gas circuit breakers, vacuum circuit breakers, air back breakers, distributing circuit breakers, electromagnetic switches, etc.) required for parallel operation between panel transformers A can be installed and used in a separate distribution board.

Next, differences between a method of selecting a transformer capacity using the distribution board having an embedded panel transformer according to the present invention and a conventional method of selecting a transformer capacity are described through comparison.

When a transformer capacity is calculated to be 900 KVA using an estimated power capacity calculation method based on intellectual classification used in typical design offices, or a calculation method based on a table of power load densities according to the usage of buildings, an existing typical transformer selection method determines a 1000 KVA×1 three-phase transformer in consideration of an expected future load increase for office automation appliances and the selection of a standard transformer capacity, and then calculates a main transformer capacity.

However, when the method of the present invention is applied, 100 KVA×9 panel transformers, or 300 KVA×3 panel transformers are selected. According to the method of the present invention, in the case of using 100 KVA×9 panel transformers, the load on a consumer unit is caused by lighting, electric heat, small scale power, computer load, etc., and is then suitable for a load requiring large scale electric power.

This method of the present invention is advantageous in that it can reduce power demand charges and reduce costs attributable to no-load power overnight because of precise power control, but is disadvantageous in that an installation area increases, so that the number of distribution boards having an embedded panel transformer may increase, and installation costs increase.

In the case of using 300 KVA×3 panel transformers according to the present invention, this is suitable for the case where an overnight load occupies a large portion of the overall load on a consumer unit, and is advantageous in that the number of distribution boards having an embedded panel transformer is reduced, so the installation cost is decreased, and the installation area is reduced.

Regardless of the method, the present invention can reduce basic charges and power demand charges thanks to the reduction in transformer capacity of about 100 KVA, compared to transformer capacity based on the conventional method, and reduce power demand charges and charges attributable to no-load power through the control of the number of operating panel transformers for time periods for daytime and nighttime.

However, the basic difference between the methods is the solution of the problem occurring when the load increases in the future, and when a single main transformer develops a fault. When the distribution board having an embedded panel transformer according to the present invention is used, the problem is simply solved by replacing only the faulty panel transformer.

As described above, in buildings or factories, since an excessive demand factor or diversity factor is applied from the beginning of construction, and a substation is constructed in consideration both of a reserve ratio and a future increase in load, excess transformer capacity may be provided in the distribution board having an embedded panel transformer of the present invention. Such excess transformer capacity results in great influence on the obtainment of the competitiveness of enterprises, and also continuously influences the management of enterprises, thus ensuring a suitable transformer capacity is considered to be very important.

In consideration of the problem, a panel transformer corresponding to a standard transformer capacity lower than the sum of load capacities in a consumer unit by one level is selected and installed at the time of designing and constructing a distribution board. If it is determined that the load is increased or the capacity of the installed panel transformer is insufficient, an additional panel transformer need only be installed. However, this problem is solved by additionally securing an auxiliary distribution boa rd.

Further, transformers formed in various shapes, such as a cube, a cylinder or a rectangular parallelepiped, are installed in a distribution board installed in a building or a structure in such a way that panel transformers having the same load characteristics, including the size and width of a casing, are standardized for each capacity and are installed according to load. In the case of a single-phase panel transformer, a standardized capacity is additionally installed for each phase, or some previously installed panel transformers are removed when capacity is left over, thus transformer capacity suitable for the actual load of a consumer unit is provided and used.

Although the preferred embodiments of the present invention have been disclosed for illustrative purposes, those skilled in the art will appreciate that various modifications, additions and substitutions are possible, without departing from the scope and spirit of the invention as disclosed in the accompanying claims. Accordingly, the detailed description and the attached drawings should be interpreted to exemplify the technical spirit of the present invention without restricting the technical spirit of the present invention.

### INDUSTRIAL APPLICABILITY

The present invention can actively cope with fluctuation in power demand in normal buildings or factories, reduce unnecessary panel transformer capacity, and disconnect some panel transformers from an electric circuit for an overnight period, thus reducing basic charges and power demand charges thanks to the reduction of no-load loss in panel transformers, the efficient operation of panel transformers based on a rated load, and the reduction of contract power from Korea Electric Power Corporation. Accordingly, the present invention can improve the competitiveness of enterprises, enable Korea Electric Power Corporation to predict a suitable actual load for each consumer unit, increase power reserve ratio owing to the reduction of transformer capacity, and implement a suitable capacity that reduces construction costs at the time of constructing an extra-high voltage substation or power station, thereby providing economic benefits both to consumers and to power suppliers because of a decrease in electric rates.

Further, if only a distribution board is additionally installed in preparation for the event of an increase in power demand, only the capacity of a panel transformer is increased without replacing all existing equipment, thus the present invention can promptly accommodate an increase in load, thus reducing additional installation costs caused by the complete replacement of substation equipment.

1. A distribution board having an embedded panel transformer, comprising: at least one panel transformer including a transformer that has a primary side high voltage power connection terminal connected to input high voltage power, a secondary side high voltage power connection terminal for outputting the high voltage power, and a secondary side low voltage power connection terminal for outputting low voltage power dropped from the input high voltage power, and that supplies usage power to a load side, and an automatic circuit breaker that is connected to the secondary side connection terminals of the transformer, has a high voltage contact point output terminal for outputting the high voltage power input from the transformer and a low voltage contact point output terminal for outputting low voltage power input from the transformer, and connects or disconnects the transformer to or from a load; a panel transformation unit including a plurality of panel transformers connected to each other in such a way that a high voltage contact point output terminal of an automatic circuit breaker, constituting a first side panel transformer, is connected to a primary side high voltage power connection terminal of a transformer, constituting a second side panel transformer; a terminal box in which low voltage power output from an automatic circuit breaker of each panel transformer, constituting the panel transformation unit, is connected to a low voltage cable; a converter installed in the terminal box, and adapted to detect the amount of load current flowing through the low voltage cable connected to the automatic circuit breaker; and a control unit for comparing the amount of load current detected by the converter with a preset reference data value, operating respective automatic circuit breakers, and connecting or disconnecting corresponding panel transformers to or from the load in response to load variation, thus controlling the number of operating panel transformers.

2. The distribution board according to claim 1, wherein each of the automatic circuit breakers comprises: a low voltage contact point input terminal connected to the secondary side low voltage power connection terminal of the transformer on an upper portion on a first side of the automatic circuit breaker, and provided with a low voltage contact point for connecting or disconnecting the low voltage power; a high voltage contact point input terminal connected to the secondary side high voltage power connection terminal of the transformer on a lower portion on the first side of the automatic circuit breaker, and provided with a high voltage contact point for connecting or disconnecting the high voltage power; and a high voltage power output terminal for outputting the high voltage power input from the transformer on a lower portion on a second side of the automatic circuit breaker.

3. The distribution board according to claim 2, wherein the panel transformers are implemented so that a plurality of panel transformers is connected in parallel to externally applied high voltage power.

4. The distribution board according to claim 2, wherein the transformers are implemented as single-phase (1Φ) or three-phase (3Φ) transformers, are standardized for each capacity, and have the same load characteristics.

5. The distribution board according to claim 4, wherein the panel transformers are implemented so that a plurality of panel transformers is connected in parallel to externally applied high voltage power.

6. The distribution board according to claim 1, wherein the transformers are implemented as single-phase (1Φ) or three-phase (3Φ) transformers, are standardized for each capacity, and have the same load characteristics.

7. The distribution board according to claim 6, wherein the load characteristics are characteristics of capacity, polarity, primary and secondary voltages, a ratio of resistance to reactance, angular displacement, phase rotation direction, and impedance voltage.

8. The distribution board according to claim 7, wherein the panel transformers are implemented so that a plurality of panel transformers is connected in parallel to externally applied high voltage power.

9. The distribution board according to claim 1, wherein the panel transformers are implemented so that a plurality of panel transformers is connected in parallel to externally applied high voltage power.

10. The distribution board according to claim 9, further comprising at least one high voltage circuit breaker placed in front of the plurality of panel transformers for inputting the high voltage power, and operated to open a corresponding high voltage contact point when an internal fault is developed in a corresponding panel transformer, thus protecting an entire circuit.
